(19) United States
(12) Patent Application Publication
(10) Pub. No.: US 2021/0089467 A1
(43) Pub. Date: Mar. 25, 2021

(54) PAGE ALLOCATION FOR CONTIGUITY-AWARE TRANSLATION LOOKASIDE BUFFERS

(71) Applicant: Intel Corporation, Santa Clara, CA (US)

(72) Inventors: Aravinda Prasad, Bangalore (IN); Sreenivas Subramoney, Bangalore (IN)

(21) Appl. No.: 17/113,801

(22) Filed: Dec. 7, 2020

(30) Foreign Application Priority Data
Oct. 1, 2020 (IN) 201041042862

(51) Int. Cl. G06F 12/1009; G06F 12/0808; G06F 12/126; G06F 9/50

(52) U.S. Cl. CPC G06F 12/1009; G06F 12/0808; G06F 2212/154; G06F 9/5016; G06F 2212/657; G06F 12/126

(57) ABSTRACT

Systems, apparatuses and methods may provide for technology that allocates a physical page for a virtual memory address associated with a fault, determines a size and layout of an address space containing the virtual memory address, and conducts a soft reservation of a set of contiguous physical memory pages based on the size and the layout of the address space.

### CROSS-REFERENCE TO RELATED APPLICATIONS

The present application claims the benefit of priority to Indian Patent Application No. 202041042862 filed on Oct. 1, 2020.

### TECHNICAL FIELD

Embodiments generally relate to memory page allocation. More particularly, embodiments relate to page allocation for contiguity-aware translation lookaside buffers (TLBs).

### BACKGROUND

A translation lookaside buffer (TLB) is a cache that maps virtual address (VAs) to physical address (PAs). TLBs may be critical to system performance as every address accessed by an application goes through the TLB cache to find the corresponding physical address. Increasing the TLB caches, however, for systems with large amount of memory (e.g., terabytes of memory) may consume considerable hardware resources (e.g., both area and power). As a result, an “address translation wall” may be encountered (e.g., a situation where address translation overheads become a major performance bottleneck).

### BRIEF DESCRIPTION OF THE DRAWINGS

FIG. 1 is a block diagram of a comparative example of conventional reservation-based allocation and reservation-based allocation according to an embodiment;

FIG. 2 is a block diagram of an example of a conventional address mapping;

FIGS. 3A and 3B are block diagrams of examples of physical page allocations for contiguity-aware TLBs according to an embodiment;

FIGS. 4A and 4B are block diagrams of examples of page allocations when contiguous physical pages are not available according to an embodiment;

FIG. 5 is a flowchart of an example of a method of operating a performance-enhanced computing system according to an embodiment;

FIGS. 6 and 7 are flowcharts of examples of methods of operating a performance-enhanced computing system in a multi-tenant cloud environment according to an embodiment;

FIG. 8 is a block diagram of an example of a performance-enhanced computing system according to an embodiment;

FIG. 9 is an illustration of an example of a semiconductor package apparatus according to an embodiment;

FIG. 10 is a block diagram of an example of a processor according to an embodiment; and

FIG. 11 is a block diagram of an example of a multi-processor based computing system according to an embodiment.

### DETAILED DESCRIPTION OF EMBODIMENTS

Numerous hardware techniques such as, for example, CoLT (Coalesced Large-Reach TLBs) have been proposed to mitigate the address translation wall. Such hardware techniques may be referred to as contiguity-aware TLBs. Contiguity-aware TLBs may use a single TLB entry to store the address translation mapping of N contiguous regions. Hence, a single entry has the flexibility to map any region of arbitrary size. For example, a single contiguity-aware TLB entry can map a 5 GB region, while it requires 1,310,720 TLB entries to map the region with normal TLBs when backed by 4K pages. An L2 (level 2) TLB cache, however, has only 1536 entries.

A requirement of contiguity-aware TLBs is that the virtual to physical address mapping is contiguous. As operating systems manage such virtual to physical mapping, the hardware supported contiguity-aware TLB feature cannot be put into effective use without suitable techniques in the operating system (OS) to allocate a set of contiguous physical pages for applications.

Embodiments provide for a novel page allocator that supports “ragged” allocation of pages to exploit the hardware supported contiguity-aware TLBs to improve TLB hits. This allocation is achieved by soft reserving the pages based on the size and layout of the virtual address space associated with the process.

Embodiments address this problem by ensuring memory contiguity at the time of page allocation by supporting “ragged” allocations. More particularly, in embodiments:
“Ragged” allocations are supported, unlike the BSD (Berkley Software Distribution, e.g., FreeBSD open source operating system) reservation-based allocator, which requires power-of-two allocations.
Reallocation to support ragged allocations is not required, whereas an OS service that recovers lost translation contiguity (e.g., TRANSLATION RANGER) and CA (contiguity-aware) paging require allocation and then reallocation to support ragged regions.

Ragged page allocations are achieved by considering the size and layout of the faulting VMA (virtual memory area) to allocate contiguous physical memory. The OS allocates the physical page for the faulting virtual address and then soft reserves a set of contiguous physical memory pages to ensure contiguity of virtual to physical address mapping. The proposed contiguity-aware page allocator ensures allocation of a contiguous set of physical pages to the application on a best-effort basis to maximize the benefits of hardware supported contiguity-aware TLBs. The contiguity-aware page allocator does not require any modifications to the application.

Previously, TRANSLATION RANGER used compaction in the operating system to maintain contiguity by coalescing scattered physical memory pages into a larger contiguous region and migrating physical pages. The approach used by TRANSLATION RANGER may be costly as migration of pages increases memory bandwidth, results in costly TLB shootdowns and often adds to application latency affecting QoS agreements.

Embodiments address this problem more fundamentally by ensuring memory contiguity at the time of page allocation. A contiguity-aware page allocator ensures on a best-effort basis that a contiguous set of physical pages are allocated to the application to maximize the benefits of hardware supported contiguity-aware TLBs. Existing techniques such as TRANSLATION RANGER can be used on top of the proposed contiguity-aware page allocator in cases where the page allocator cannot find a contiguous set of pages due to memory fragmentation.

CA paging is a technique that ensures a larger-than-a-page contiguous mapping at the time of the first page fault on a virtual memory region. This technique looks for a best-fit contiguous physical memory region to map a virtual address space. CA paging allocates only a single physical page for the faulting virtual address. The rest of the physical pages in the contiguous region are allocated when the corresponding virtual addresses incurs a page fault (similar to demand paging). It is therefore possible that other applications (even when there is no memory pressure) can page fault and have a physical page allocated from the region identified above.

Embodiments described herein soft reserve the entire physical address range upon the first page fault on a virtual address region (unlike demand paging) to ensure such physical pages are not allocated to other applications. Soft reservation is invalidated only when the system is under memory pressure. This ensures that contiguous mapping is not unnecessarily broken. Furthermore, embodiments allocate contiguity-aware regions to a process or a set of process based on the selection criteria such as: process priority, process belonging to a certain user groups (e.g., paid users in a multi-tenure cloud environment) or other user defined criteria. In addition, embodiments also define fine grained allocation of contiguity-aware regions within a process virtual address space based on the virtual memory attributes such as heap, stack, memory mapped region.

A reservation-based paging strategy used in FreeBSD does not support “ragged” allocations. In BSD reservation-based allocation, the reservation size is fixed to a large page size boundary, which is optimal for VMA regions that are multiple of large page size on traditional TLBs (as traditional TLBs are tied to hardware supported page sizes). The large page size boundary is not optimal, however, for arbitrary-sized VMA regions, particularly on systems with contiguity-aware TLBs because contiguity-aware TLBs are not dependent on hardware supported page sizes.

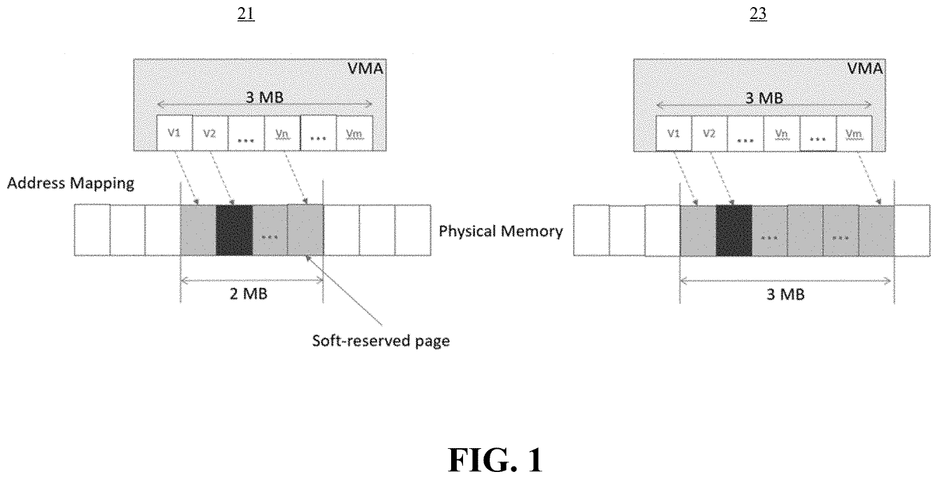

For example, FIG. 1 demonstrates in a conventional allocation 21 that when an application mmaps (memory maps) a 3 MB region, the BSD reservation-based allocation can only reserve 2 MB of contiguous physical memory. An enhanced allocation 23, however, can reserve 3 MB of contiguous physical memory.

The contiguity-aware page allocator technology described herein maximizes the number of contiguous physical memory regions to exploit the benefits of hardware supported contiguity-aware TLBs by supporting ragged allocations. This support is achieved by taking into consideration the size and layout of the process's VMA at the time of allocating the physical memory. This technique effectively mitigates the “address translation wall”.

Embodiments may reduce up to 99% of the number of TLB entries required for high memory footprint applications. These reductions in turn can significantly reduce the total cycles spent in page table walks and can thus improve application/system performance. Doing so avoids costly techniques such as compaction that migrates pages to ensure maximum contiguity.

### Additional Details

Demand paging is used to allocate physical frames/pages to back the virtual memory address of a process. Demand paging allocates a physical page only when the virtual memory area (VMA) is accessed by the process. After such allocation, the translations that map virtual address (VAs) to physical address (PAs) are cached in TLB.

Conventional page allocators in the OS such as the “Buddy” allocator in the LINUX kernel do not consider contiguity when allocating pages for applications. To explain in detail, the physical memory is managed by OS in hardware supported base page size granularity (4K for Intel architectures) and a page is allocated when an application page faults on a virtual address. Hence allocations are always at the base page size granularity for applications. An exception is when a virtual memory region is backed by large pages (e.g., 2M/4M), where a contiguous large page physical memory region is attempted for allocations.

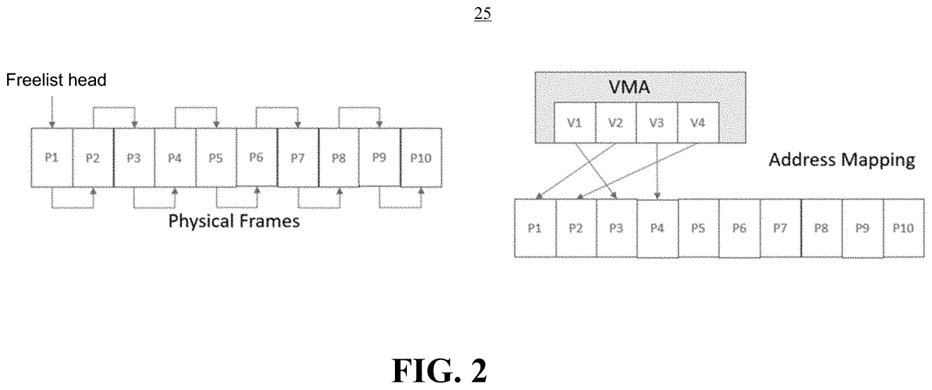

FIG. 2 shows a page allocation strategy 25 of the Buddy allocator in the LINUX kernel, which fails to ensure VA to PA contiguity even when contiguous physical memory is available. The Buddy allocator maintains a per-CPU (central processing unit) list of free pages of size 4K to ensure efficient allocation of pages when an application page faults. If an application VMA consisting of four virtual pages starts page faulting in the following sequence: V2, V4, V1, V3, the Buddy allocator allocates pages from the free list in this order: P1, P2, P3 and P4. Even though there are four contiguous physical pages allocated, the pages are not contiguous in the virtual address space. Such a VA to PA address mapping requires 4 TLB entries (V1->P3; V2->P1; V3->P4 and V4->P2) even with contiguity-aware TLBs. The Buddy allocator therefore fails to ensure contiguity as it is not aware of virtual memory size and layout.

A VMA size and layout aware page allocator as described herein would have allocated pages in P2, P4, P1 and P3 order such that a single contiguity-aware TLB entry ([V1:V4]->[P1:P4]) maps the entire VMA.

Thus, conventional page allocators are not aware of the size and layout of the VMA and cannot ensure contiguity at the time of allocating a physical page.

### Solution

Embodiments include a page allocator for contiguity-aware TLBs. The novelty of the proposed page allocator is that it supports “ragged” allocations. Upon a page fault in a virtual address, the allocator considers the size and layout of the faulting VMA to allocate a physical page and soft reserves the physical memory pages to serve future requests. Previous page allocators such as the Buddy allocator in the LINUX kernel can allocate only power-of-two contiguous physical pages and do not consider the VMA size and layout to optimize physical page allocation.

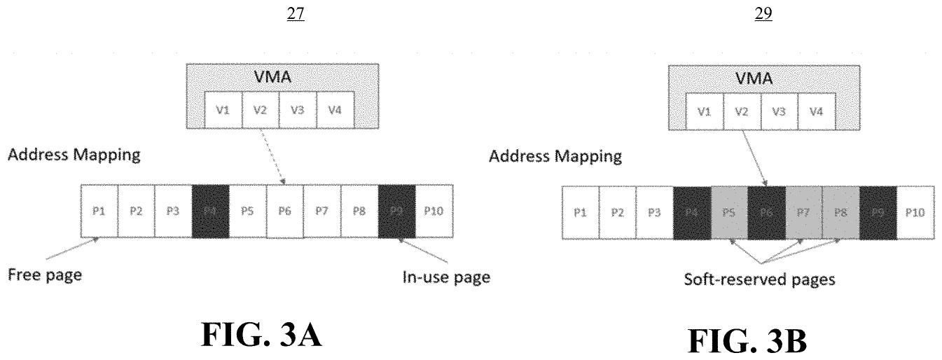

FIG. 3A shows a physical page allocation 27 in which in-use and free pages exist at the time when virtual page V2 page faults. Unlike conventional solutions, which pick the first free page available (e.g., P1), the page allocator described herein considers the VMA size and layout while allocating a page. From the VMA layout, the page allocator finds that faulting is occurring on the second virtual page in the VMA and the VMA has four virtual pages that have not been accessed yet. Accordingly, the page allocator finds a region with four contiguous physical pages and allocates the second physical page P6 for V2 and soft reserves the rest of the physical pages P5, P7 and P8 for the virtual pages V1, V3 and V4 as shown in a physical page allocation 29 in FIG. 3B. The soft reservation will ensure that these pages are not allocated to a different VMA or to a different process until there is a memory pressure in the system. Therefore, when the application later page faults on V1, V3 and V4, contiguous physical pages that are soft reserved are allocated. This ensures that only one contiguity-aware TLB entry ([V1:V4]->[P5:P8]) maps the entire region.

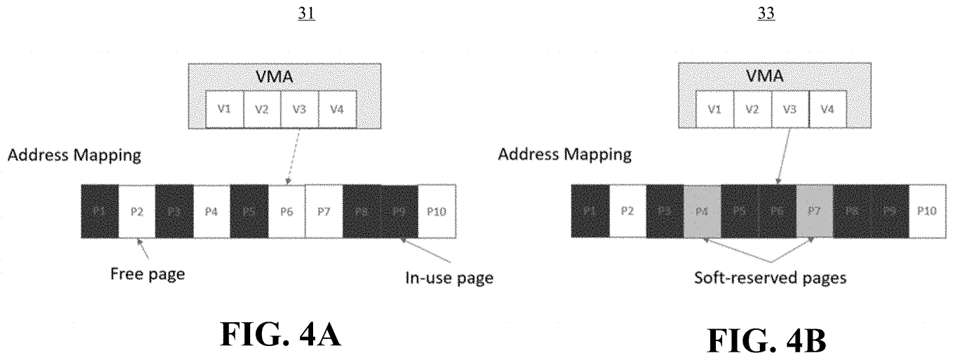

It is possible, however, that the required number of contiguous physical pages are not available when a VMA region page faults as shown in a page allocation 31 in FIG. 4A. When V3 page faults, there are no contiguous physical pages available to accommodate the size and layout of the VMA. In such cases, the page allocator described herein attempts to minimize the number of contiguity-aware TLB entries required and ensures that only minimal number of page migration are required to reclaim contiguity. As shown in a page allocation 33 in FIG. 4B, the page allocator may allocate P6 for V3, soft reserve the free pages P4 and P7, and further mark P5 for background page migration. Therefore, when V2 later page faults, P5 can be allocated if migration is complete. This strategy maximizes the contiguity while minimizing the number of page migrations required.

### Procedure

The following procedure describes the contiguity-aware page allocator. The page fault handler first validates the faulting address by checking the address boundaries and access permissions and then invokes alloc_page( ) with the faulting virtual address.

ALLOC_PAGE(virtual_address VA)

{

1. Get the VMA and virtual page address associated with the faulting virtual address VA. The LINUX kernel exports calls/macros to fetch the VMA and virtual page associated with the faulting virtual address.

2. Compute the size of the VMA, the anchor page (the first virtual page address in the VMA) and the virtual page offset of the faulting VA inside the VMA.

3. Look for soft reserved physical pages for this VMA. If such pages exist, allocate the soft reserved page for the faulting virtual page and EXIT. If no soft reserved pages found, go to next Operation.

4. Search for contiguous free physical pages that can map the entire VMA. Use either best fit or first fit or any other known algorithm/heuristics to find the contiguous free physical pages. If contiguous physical pages are not available go to Operation 7.

5. Map the faulting virtual page to the corresponding physical page in the contiguous free physical pages found in the above Operation.

6. Soft reserve the rest of the pages and EXIT.

7. Find a contiguous physical memory region that has a minimal number of already allocated pages. Map the faulting virtual page to the corresponding physical page in the region thus found. Mark all free physical pages in this region as soft reserved. Mark all allocated pages in this region for background page migration.}

Embodiments also include a contiguity-aware page allocator to manage soft reservations. These techniques can be used by suitably enhancing the above procedure.

### Additional Embodiments for Managing Soft Reservations

The Soft reservation technique can be made available to paid users in a multi-tenure cloud environment (e.g., performance-as-a-service/PaaS model). Processes or applications belonging to a paid user (e.g., subscriber) in a multi-tenure cloud environment is prioritized: (i) soft reservations of such applications cannot be invalidated even during memory pressure (e.g., OS can restore to swapping of pages for applications belonging to unpaid users), (ii) applications of paid user can invalidate soft reservations associated with non-paid users. Similarly, this approach may be extended based on process priority. For example, invalidating a soft reservation associated with a high priority process is not allowed, while a high priority process invalidates soft reservations of low priority processes. Soft reservations may also be applied to a portion/subset of a virtual address space. For example, the page allocator may use a policy to apply soft reservations only for the heap, stack or memory mapped region of an application.

### Additional Embodiments for Allocating a Contiguous Region

Heuristics may be used in Operation 4 to determine the aggressiveness of the algorithm to attempt to find the contiguous free physical pages. This approach enables a tradeoff between allocation latency and TLB hit rates. In Operation 7, heuristics may be used to determine the rate and time for page migration. It is also possible to migrate pages in the foreground instead of migrating in the background depending on the application requirements. Also in Operation 7, migration may be avoided based on the performance impact on the memory bandwidth utilization. Even without migration, the technology described herein minimizes the number of contiguity-aware TLBs entries required when compared to existing page allocators.

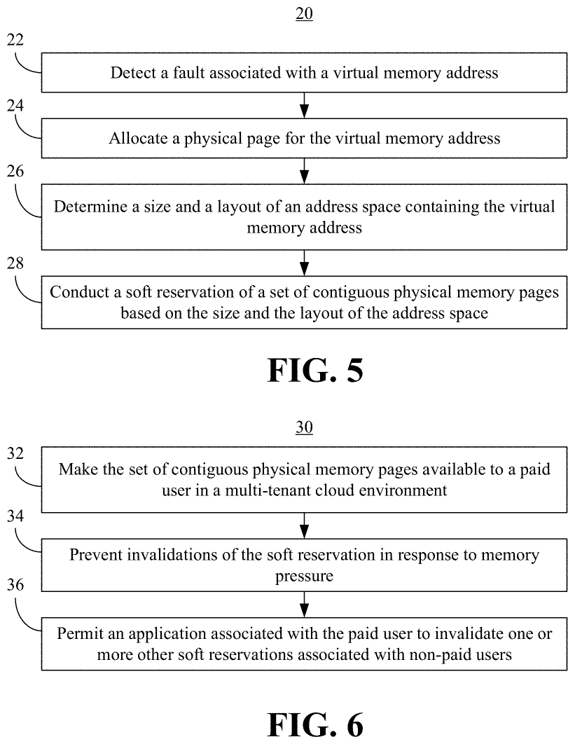

FIG. 5 shows a method 20 of operating a performance-enhanced computing system. The method 20 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The illustrated processing block 22 provides for detecting a fault associated with a virtual memory address. In an embodiment, block 22 involves determining that an exception has been raised by computer hardware because a running program accessed a memory page that is not currently mapped by a memory management unit (MMU) into the virtual address space of a process. Block 24 may allocate a physical page for the virtual memory address associated with the fault. In one example, block 26 determines a size and a layout of an address space containing the virtual memory address, where block 28 conducts a soft (e.g., capable of being invalidated) reservation of a set of contiguous physical memory pages based on the size and the layout of the address space. In an embodiment, the soft reservation is conducted via a request that the OS prevent other applications from using the set of contiguous physical memory pages (e.g., making the reserved pages available to be committed). Additionally, the soft reservation may be limited to a portion (e.g., heap, stack) of the address space.

The method 20 therefore enhances performance at least to the extent that conducting the soft reservation reduces the number of TLB entries used for high memory footprint applications. As already noted, these reductions may in turn significantly reduce the total cycles spent in page table walks, which improves application and/or system performance. Moreover, the method 20 avoids costly techniques such as compaction, which migrates pages to ensure maximum contiguity.

FIG. 6 shows a method 30 of operating a performance-enhanced computing system in a multi-tenant cloud environment. The method 30 may generally be implemented in conjunction with the method 20 (FIG. 5), already discussed. More particularly, the method 30 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated block 32 makes the set of contiguous physical memory pages available to a paid user (e.g., subscriber) in the multi-tenant cloud environment. Additionally, block 34 may prevent invalidations of the soft reservation. The attempted invalidations may be the result of, for example, memory pressure. In an embodiment, block 36 permits an application associated with the paid user to invalidate one or more other soft reservations associated with non-paid (e.g., non-subscribed) users. The method 30 therefore further enhances performance by facilitating contiguity-aware TLBs in a multi-tenant setting.

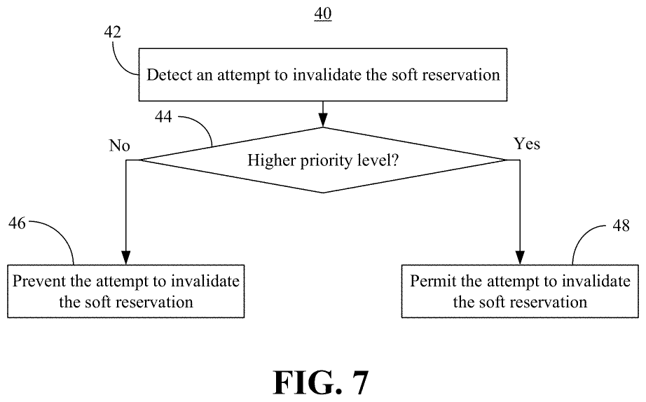

FIG. 7 shows another method 40 of operating a performance-enhanced computing system in a multi-tenant cloud environment. The method 40 may generally be implemented in conjunction with the method 20 (FIG. 5) and/or the method 30 (FIG. 4), already discussed. More particularly, the method 40 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated block 42 provides for detecting an attempt to invalidate the soft reservation, where block 44 determines whether the attempt is by an application having a higher priority level than the application (e.g., first application) that made the soft reservation. If not, block 46 prevents the attempt to invalidate the soft reservation. Thus, if the attempt is by a second application having a second priority level that is lower than a first priority level associated with the first application, block 46 is executed. If, however, it is determined at block 44 that the attempt is by an application having a higher priority level than the application that made the soft reservation, block 48 permits the attempt to invalidate the soft reservation. Thus, if the attempt is by a third application having a third priority level that is higher than the first priority level associated with the first application, block 48 is executed. The illustrated method 40 therefore further enhances performance by enabling the prioritization of applications in a multi-tenant setting.

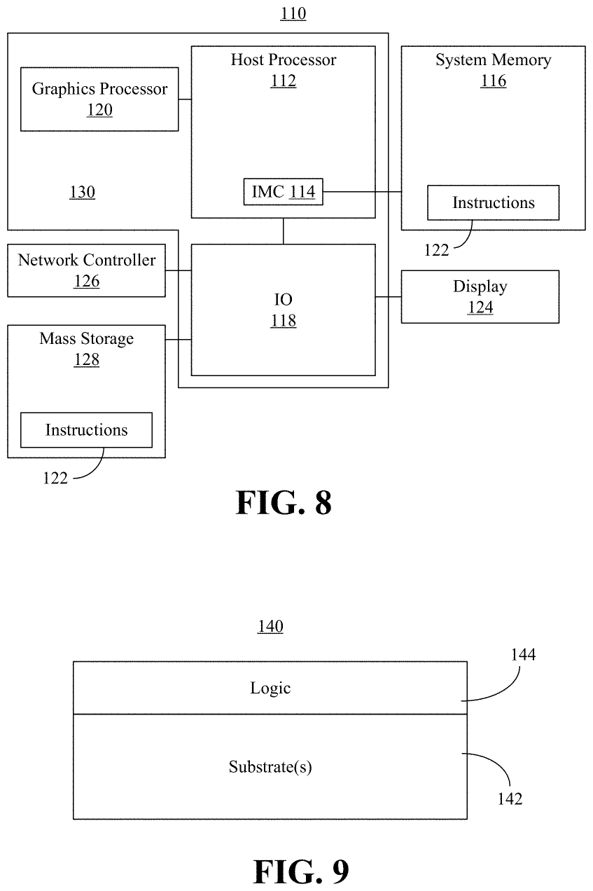

Turning now to FIG. 8, a performance-enhanced computing system 110 is shown. The system 110 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 110 includes a host processor 112 (e.g., CPU) having an integrated memory controller (IMC) 114 that is coupled to a system memory 116. In an embodiment, an IO module 118 is coupled to the host processor 112. The illustrated IO module 118 communicates with, for example, a display 124 (e.g., touch screen, liquid crystal display/LCD, light emitting diode/LED display), a network controller 126 (e.g., wired and/or wireless), and a mass storage 128 (e.g., hard disk drive/HDD, optical disc, solid-state drive/SSD, flash memory, etc.). The system 110 may also include a graphics processor 120 (e.g., graphics processing unit/GPU) that is incorporated with the host processor 112 and the IO module 118 into a system on chip (SoC) 130.

In one example, the system memory 116 and/or the mass storage 128 includes a set of executable program instructions 122, which when executed by the SoC 130, cause the SoC 130 and/or the computing system 110 to implement one or more aspects of the method 20 (FIG. 5), the method 30 (FIG. 6) and/or the method 40 (FIG. 7), already discussed. Thus, the SoC 130 may execute the instructions 122 to allocate a physical page for a virtual memory address associated with a fault, determine a size and layout of an address space containing the virtual memory address, and conduct a soft reservation of a set of contiguous physical memory pages based on the size and the layout of the address space. In an embodiment, the physical memory pages are located in the system memory 116.

The computing system 110 is therefore performance-enhanced at least to the extent that conducting the soft reservation reduces the number of TLB entries used for high memory footprint applications. As already noted, these reductions may in turn significantly reduce the total cycles spent in page table walks, which improves application and/or system performance. Moreover, the computing system 110 avoids costly techniques such as compaction, which migrates pages to ensure maximum contiguity.

FIG. 9 shows a semiconductor apparatus 140 (e.g., chip and/or package including an auxiliary processor). The illustrated apparatus 140 includes one or more substrates 142 (e.g., silicon, sapphire, gallium arsenide) and logic 144 (e.g., transistor array and other integrated circuit/IC components) coupled to the substrate(s) 142. In an embodiment, the logic 144 implements one or more aspects of the method 20 (FIG. 5), the method 30 (FIG. 6) and/or the method 40 (FIG. 7), already discussed. Thus, the logic 144 may allocate a physical page for a virtual memory address associated with a fault, determine a size and layout of an address space containing the virtual memory address, and conduct a soft reservation of a set of contiguous physical memory pages based on the size and the layout of the address space.

The logic 144 may be implemented at least partly in configurable logic or fixed-functionality hardware logic. In one example, the logic 144 includes transistor channel regions that are positioned (e.g., embedded) within the substrate(s) 142. Thus, the interface between the logic 144 and the substrate(s) 142 may not be an abrupt junction. The logic 144 may also be considered to include an epitaxial layer that is grown on an initial wafer of the substrate(s) 142.

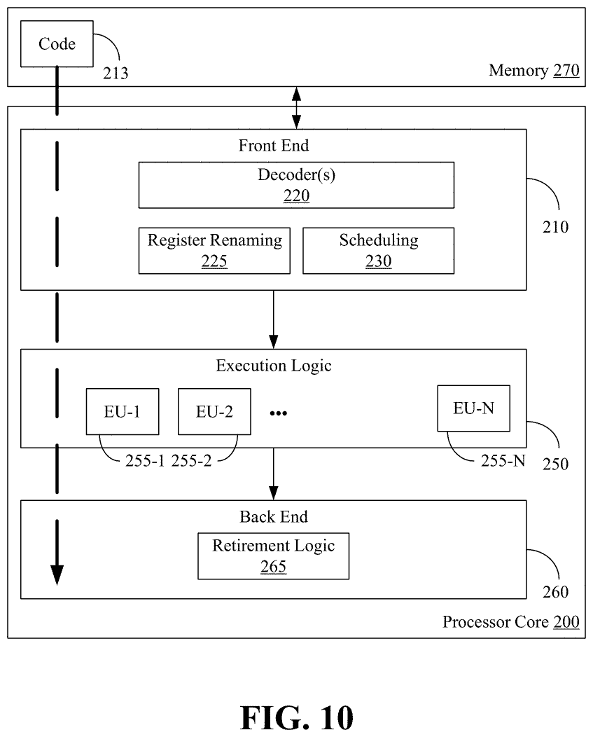

FIG. 10 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 10, a processing element may alternatively include more than one of the processor core 200 illustrated in FIG. 10. The processor core 200 may be a single-threaded core or, for at least one embodiment, the processor core 200 may be multithreaded in that it may include more than one hardware thread context (or “logical processor”) per core.

FIG. 10 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 20 (FIG. 5), the method 30 (FIG. 6) and/or the method 40 (FIG. 7), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 10, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

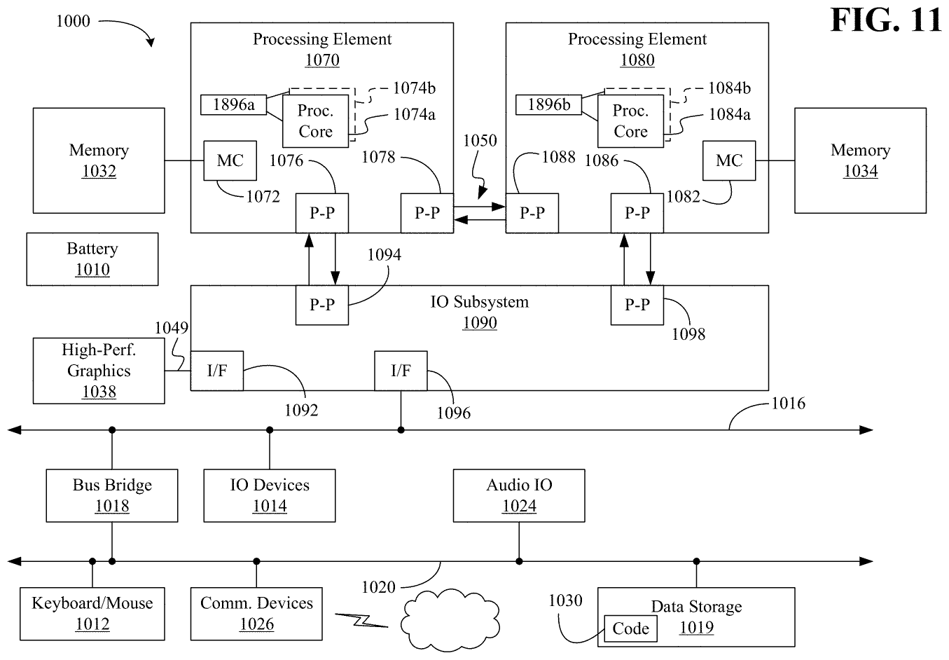

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 20 (FIG. 5), the method 30 (FIG. 6) and/or the method 40 (FIG. 7), already discussed, and may be similar to the code 213 (FIG. 10), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### Additional Notes and Examples

Example 1 includes a performance-enhanced computing system comprising a network controller, a processor coupled to the network controller, and a memory coupled to the processor, the memory including a set of executable program instructions, which when executed by the processor, cause the processor to allocate a physical page for a virtual memory address associated with a fault, determine a size and a layout of an address space containing the virtual memory address, and conduct a soft reservation of a set of contiguous physical memory pages based on the size and the layout of the address space.

Example 2 includes the computing system of Example 1, wherein the instructions, when executed, cause the computing system to make the set of contiguous physical memory pages available to a paid user in a multi-tenant cloud environment.

Example 3 includes the computing system of Example 2, wherein the instructions, when executed, cause the computing system to prevent invalidations of the soft reservation in response to memory pressure, and permit an application associated with the paid user to invalidate one or more other soft reservations associated with non-paid users.

Example 4 includes the computing system of Example 1, wherein the soft reservation is to be associated with a first application having a first priority level, and wherein the instructions, when executed, cause the computing system to prevent an invalidation of the soft reservation by a second application having a second priority level that is lower than the first priority level, and permit an invalidation of the soft reservation by a third application having a third priority level that is higher than the first priority level.

Example 5 includes the computing system of Example 1, wherein the soft reservation is to be limited to a portion of the address space.

Example 6 includes the computing system of any one of Examples 1 to 5, wherein the instructions, when executed, further cause the computing system to detect the fault with respect to the virtual memory address.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to allocate a physical page for a virtual memory address associated with a fault, determine a size and a layout of an address space containing the virtual memory address, and conduct a soft reservation of a set of contiguous physical memory pages based on the size and the layout of the address space.

Example 8 includes the apparatus of Example 7, wherein the logic coupled to the one or more substrates is to make the set of contiguous physical memory pages available to a paid user in a multi-tenant cloud environment.

Example 9 includes the apparatus of Example 8, wherein the logic coupled to the one or more substrates is to prevent invalidations of the soft reservation in response to memory pressure, and permit an application associated with the paid user to invalidate one or more other soft reservations associated with non-paid users.

Example 10 includes the apparatus of Example 7, wherein the soft reservation is to be associated with a first application having a first priority level, and wherein the logic coupled to the one or more substrates is to prevent an invalidation of the soft reservation by a second application having a second priority level that is lower than the first priority level, and permit an invalidation of the soft reservation by a third application having a third priority level that is higher than the first priority level.

Example 11 includes the apparatus of Example 7, wherein the soft reservation is to be limited to a portion of the address space.

Example 12 includes the apparatus of any one of Examples 7 to 11, wherein the logic coupled to the one or more substrates is to detect the fault with respect to the virtual memory address.

Example 13 includes the apparatus of any one of Examples 7 to 11, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to allocate a physical page for a virtual memory address associated with a fault, determine a size and a layout of an address space containing the virtual memory address, and conduct a soft reservation of a set of contiguous physical memory pages based on the size and the layout of the address space.

Example 15 includes the at least one computer readable storage medium of Example 14, wherein the instructions, when executed, cause the computing system to make the set of contiguous physical memory pages available to a paid user in a multi-tenant cloud environment.

Example 16 includes the at least one computer readable storage medium of Example 15, wherein the instructions, when executed, cause the computing system to prevent invalidations of the soft reservation in response to memory pressure, and permit an application associated with the paid user to invalidate one or more other soft reservations associated with non-paid users.

Example 17 includes the at least one computer readable storage medium of Example 14, wherein the soft reservation is to be associated with a first application having a first priority level, and wherein the instructions, when executed, cause the computing system to prevent an invalidation of the soft reservation by a second application having a second priority level that is lower than the first priority level, and permit an invalidation of the soft reservation by a third application having a third priority level that is higher than the first priority level.

Example 18 includes the at least one computer readable storage medium of Example 14, wherein the soft reservation is to be limited to a portion of the address space.

Example 19 includes the at least one computer readable storage medium of any one of Examples 14 to 18, wherein the instructions, when executed, further cause the computing system to detect the fault with respect to the virtual memory address.

Example 20 includes a method comprising allocating a physical page for a virtual memory address associated with a fault, determining a size and a layout of an address space containing the virtual memory address, and conducting a soft reservation of a set of contiguous physical memory pages based on the size and the layout of the address space.

Example 21 includes the method of Example 20, further comprising making the set of contiguous physical memory pages available to a paid user in a multi-tenant cloud environment.

Example 22 includes the method of Example 21, further comprising preventing invalidations of the soft reservation in response to memory pressure, and permitting an application associated with the paid user to invalidate one or or more other soft reservations associated with non-paid users.

Example 23 includes the method of Example 20, wherein the soft reservation is associated with a first application having a first priority level, and wherein the method further comprises preventing an invalidation of the soft reservation by a second application having a second priority level that is lower than the first priority level, and permitting an invalidation of the soft reservation by a third application having a third priority level that is higher than the first priority level.

Example 24 includes the method of Example 20, wherein the soft reservation is limited to a portion of the address space.

Example 25 includes the method of any one of Examples 20 to 24, further including detecting the fault with respect to the virtual memory address.

Example 26 includes means for performing the method of any one of Examples 20 to 25.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of executable program instructions, which when executed by the processor, cause the processor to:
allocate a physical page for a virtual memory address associated with a fault,
determine a size and a layout of an address space containing the virtual memory address, and
conduct a soft reservation of a set of contiguous physical memory pages based on the size and the layout of the address space.

2. The computing system of claim 1, wherein the instructions, when executed, cause the computing system to make the set of contiguous physical memory pages available to a paid user in a multi-tenant cloud environment.

3. The computing system of claim 2, wherein the instructions, when executed, cause the computing system to:
prevent invalidations of the soft reservation in response to memory pressure, and
permit an application associated with the paid user to invalidate one or more other soft reservations associated with non-paid users.

4. The computing system of claim 1, wherein the soft reservation is to be associated with a first application having a first priority level, and wherein the instructions, when executed, cause the computing system to:
prevent an invalidation of the soft reservation by a second application having a second priority level that is lower than the first priority level, and
permit an invalidation of the soft reservation by a third application having a third priority level that is higher than the first priority level.

5. The computing system of claim 1, wherein the soft reservation is to be limited to a portion of the address space.

6. The computing system of claim 1, wherein the instructions, when executed, further cause the computing system to detect the fault with respect to the virtual memory address.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
allocate a physical page for a virtual memory address associated with a fault;
determine a size and a layout of an address space containing the virtual memory address; and
conduct a soft reservation of a set of contiguous physical memory pages based on the size and the layout of the address space.

8. The apparatus of claim 7, wherein the logic coupled to the one or more substrates is to make the set of contiguous physical memory pages available to a paid user in a multi-tenant cloud environment.

9. The apparatus of claim 8, wherein the logic coupled to the one or more substrates is to:
prevent invalidations of the soft reservation in response to memory pressure; and
permit an application associated with the paid user to invalidate one or more other soft reservations associated with non-paid users.

10. The apparatus of claim 7, wherein the soft reservation is to be associated with a first application having a first priority level, and wherein the logic coupled to the one or more substrates is to:
prevent an invalidation of the soft reservation by a second application having a second priority level that is lower than the first priority level; and
permit an invalidation of the soft reservation by a third application having a third priority level that is higher than the first priority level.

11. The apparatus of claim 7, wherein the soft reservation is to be limited to a portion of the address space.

12. The apparatus of claim 7, wherein the logic coupled to the one or more substrates is to detect the fault with respect to the virtual memory address.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
allocate a physical page for a virtual memory address associated with a fault;
determine a size and a layout of an address space containing the virtual memory address; and
conduct a soft reservation of a set of contiguous physical memory pages based on the size and the layout of the address space.

15. The at least one computer readable storage medium of claim 14, wherein the instructions, when executed, cause the computing system to make the set of contiguous physical memory pages available to a paid user in a multi-tenant cloud environment.

16. The at least one computer readable storage medium of claim 15, wherein the instructions, when executed, cause the computing system to:
prevent invalidations of the soft reservation in response to memory pressure; and
permit an application associated with the paid user to invalidate one or more other soft reservations associated with non-paid users.

17. The at least one computer readable storage medium of claim 14, wherein the soft reservation is to be associated with a first application having a first priority level, and wherein the instructions, when executed, cause the computing system to:
prevent an invalidation of the soft reservation by a second application having a second priority level that is lower than the first priority level; and
permit an invalidation of the soft reservation by a third application having a third priority level that is higher than the first priority level.

18. The at least one computer readable storage medium of claim 14, wherein the soft reservation is to be limited to a portion of the address space.

19. The at least one computer readable storage medium of claim 14, wherein the instructions, when executed, further cause the computing system to detect the fault with respect to the virtual memory address.

20. A method comprising:
allocating a physical page for a virtual memory address associated with a fault;
determining a size and a layout of an address space containing the virtual memory address; and
conducting a soft reservation of a set of contiguous physical memory pages based on the size and the layout of the address space.

21. The method of claim 20, further comprising making the set of contiguous physical memory pages available to a paid user in a multi-tenant cloud environment.

22. The method of claim 21, further comprising:
preventing invalidations of the soft reservation in response to memory pressure; and
permitting an application associated with the paid user to invalidate one or or more other soft reservations associated with non-paid users.

23. The method of claim 20, wherein the soft reservation is associated with a first application having a first priority level, and wherein the method further comprises:
preventing an invalidation of the soft reservation by a second application having a second priority level that is lower than the first priority level; and
permitting an invalidation of the soft reservation by a third application having a third priority level that is higher than the first priority level.

24. The method of claim 20, wherein the soft reservation is limited to a portion of the address space.

25. The method of claim 20, further including detecting the fault with respect to the virtual memory address.
